(19) United States
(12) Patent Application Publication
(10) Pub. No.: US 2007/0107517 A1
(43) Pub. Date: May 17, 2007

(54) Verification of Continuity

(76) Inventors: David Howard Arnold, Weybridge (GB); Robert Julian Dickinson, London (GB)

Correspondence Address: David Arnold, 20 Pine Grove, Weybridge, KT13 9AW, GB

(21) Appl. No.: 11/556,708

(22) Filed: Nov. 6, 2006

(30) Foreign Application Priority Data
Nov. 10, 2005 (GB) 0522899.4

(51) Int. Cl. G01N 29/04

(52) U.S. Cl. 73/584

(57) ABSTRACT

Techniques are described for eliminating the potential continuity errors in fluid connection devices, such as tubes, which can arise in complex systems where many tubes are used. The techniques are based upon the use of ultrasound, light or pressure waves being transmitted along the connecting device using a transmitter and a receiver at either end. Methods are described to cover the external coupling of the transmitter and/or the receiver into the tubing thereby eliminating the need to compromise the connection. The described apparatus can be external to the system or integrated within it. The potential to carry information along the connection device is also disclosed.

### CROSS REFERENCE TO RELATED APPLICATIONS

This application claims priority to and the benefit of the following application GB 0522899.4 filed Nov. 10, 2005.

### BACKGROUND OF THE INVENTION

The use of plastic or glass tubing as a connecting device for fluids is well known and is used extensively in a wide range of applications such as in the food/beverage and medical fields. The tubing provides a contained method by which fluids are transferred from one point to another; the transfer may be gravity fed or pumped.

In some applications there may be many tubes in close proximity which are indistinguishable from each other as they have similar or identical form. This leads to ambiguity regarding which is the correct tube to use and the likelihood that incorrect connections will be made.

An example of this situation is in hospital operating theatres where tubes (“line sets”) are used to connect fluids in i/v bags to delivery units; the fluid transfer may be pumped or gravity fed. Typically there are a number of line sets used, may be 10 or more, and within the confined and crowded environment of the operating theatre it is a simple error to make an incorrect connection. This can lead to disastrous consequences including the death of a patient. One prior art solution to prevent such potential errors is to use a range of different connector pairs arranged so each connector will only mate with its pair, and with no other connector. Another solution is to use “smart” links for example using electrical wires or optical fibres embedded within the tube walls. Both these solutions require the use of non-standard and expensive parts to replace an item that is used once and then disposed of. What is required is a simple means by which connections can be verified using current line sets.

### SUMMARY OF THE INVENTION

The primary objective of this invention is to provide a cost-effective and simple methodology to ensure that the correct fluid source is used, either via a gravity fed system or via a pumped arrangement. The invention is based on using pulses of either ultrasound, light or pressure being transmitted along the tube from one end to the other. The pressure pulse can be in the form of a burst of sound or a single impulse. A transmitter provides the source of ultrasound, light or pressure and the receiver detects the ultrasound, light or pressure as appropriate. The transmitter and receiver are clamped around the tube in order to couple the energy into it. The transmitter can be free standing or can be coupled into a pump; the receiver can also be free standing or can be integrated with a pump. In an alternative arrangement a machine readable tag is attached onto the bag to identify the bag contents and can be checked with a reader that communicates with the pump. This reader also houses the transmitter for the continuity check. The pump can then control the operation of the transmitter and the receiver.

Accordingly it is an object of this invention to provide a simple and cost effective method by which the two ends of a tube can identified, therefore ensuring that the correct connection is made and minimising the chances of error. It is another object of this invention to provide a device which can be integrated within the pump controlling fluid delivery, thereby ensuring that the correct fluid is connected to the pump.

It is a further object to provide a means by which the identity of the i/v bag is automatically sent to the pump.

### BRIEF DESCRIPTION OF THE DRAWINGS

The invention is hereinafter more particularly described by reference to the accompanying drawings, in which:—

FIG. 1 shows a schematic of a tube of with two ends with a transmitter and receiver mounted on to the two ends.

FIG. 2 shows a schematic of a tube with a transmitter and receiver embedded into a system with a bag and a pump.

FIG. 3 shows the transmitter/receiver (transceiver) arrangement for the preferred embodiment using ultrasound.

### DESCRIPTION OF THE PREFERRED EMBODIMENTS

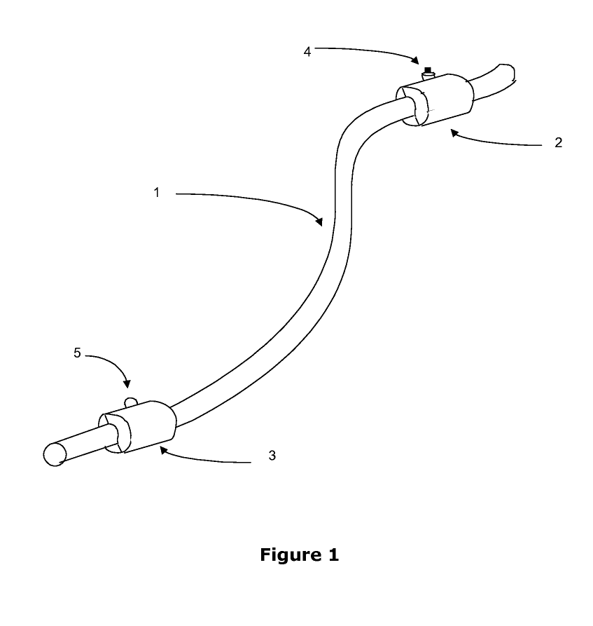

As shown in FIG. 1 a flexible plastic tube 1 is used to transfer fluids from one end to the other, the method of transfer being either gravity fed or pumped. In its simplest embodiment a source of pulsed pressure or light will be applied to one end of the tube using a transmitter 2 clamped around the tube. At the other end a receiver 3 would be clamped around the tube to detect the pulsed pressure or light as appropriate. The transmitter or receiver do not require any preferred orientation relative to the tube.

In the most basic embodiment the transmitter is operated manually with a switch 4 mounted on the transmitter. An indicator 5 on the receiver will only activate if it receives the pulse from the transmitter on the same tube. The indicator may be a light emitting diode or a beeper. The transmitter and receiver can be hinged cylinders that clamp around the tube, and can be removed and re-positioned without removing the tube.

The transmitter may consist of either a pulsed light source or a pulsed pressure or ultrasound source. In its embodiment as a light source a near monochromatic source, such as a semiconductor laser, would be used. The operating wavelength of the light source would be in the near UV, visible and near IR regions of the electromagnetic spectrum. The receiver would use a spiked optical filter with maximum transmission at the transmitter's operating wavelength to reduce the effects of external light sources. The receiver would comprise a solid state light detector (e.g. silicon photo-diode) or similar.

If pressure is used then the transmitter may produce a pressure pulse. Alternatively a pulsed sound source operating at frequencies between 5 Hz and 5,000 Hz may be used. The receiver comprises a suitable microphone, amplifier and control electronics that is in the synchronised detection mode to reduce the potential interference effects of external acoustic noise sources.

In the embodiment using ultrasound, a piezo-electric transducer is used to generate/receive ultrasound, and this is mounted on a clamp-on device to couple ultrasound into the tube. The same device can be used to transmit and receive ultrasound. The tube then acts as an ultrasound waveguide to couple the ultrasound pulse from one end to the other.

The transmitter signal produced may be in the form of a modulated code that can be detected and decoded by the receiver. The code may be pulse, amplitude or frequency modulated using well-known signal processing techniques. The receiver is arranged to only be sensitive to the transmitted code. This arrangement will thus reduce the likelihood of false indication due to noise or interference, or due to cross-talk from a nearby transmitter that is connected to a different tube.

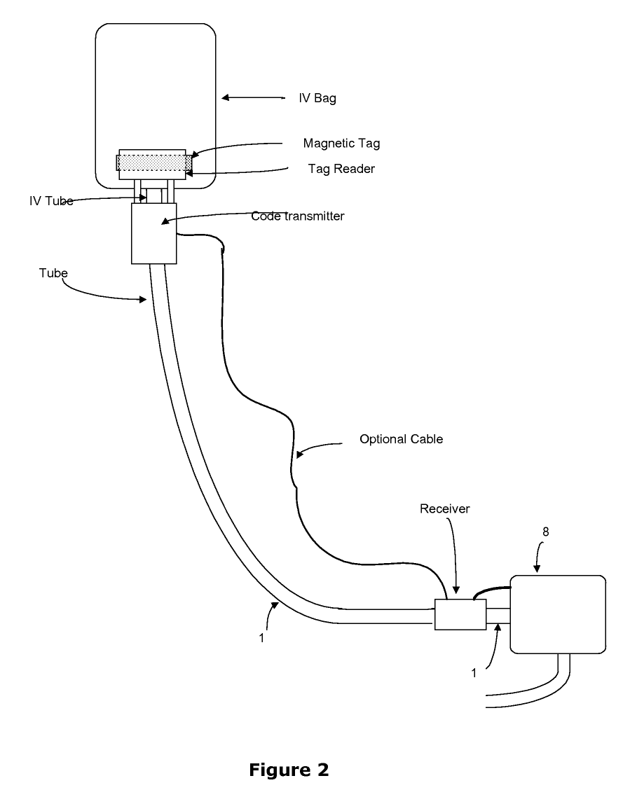

FIG. 2 shows an arrangement where the transmitter and receiver are embedded in a pumped drug delivery system. The tube 1 is connected to a drug bag 6 or other container on which is mounted a machine readable tag 7. The tag can be an optical bar code, a radio-frequency identification chip, or a magnetic tag as disclosed in UK patent application GB 0420848.4. The tag may contain coded information about the contents 10 of the bag 6. The transmitter 2 connected to this end of the tube has mounted on it a reader 8 that will read the identity of the tag 7. Information about the identity will then be transmitted along the tube 1 to the receiver 3. The information about the identity may be the numerical identity itself, or just a Yes/No signal that verifies whether the identity is correct. The receiver 3 is connected to a pump 8, and will control the pump according the identity information received. The control may be to control the pumping rate according to the identity, or may disable the pumping if the correct identity signal is not received. Information about the bag contents and the pump may need to be passed between the transmitter and receiver using a connection 9. The connection may be made using a cable or can be a wireless connection.

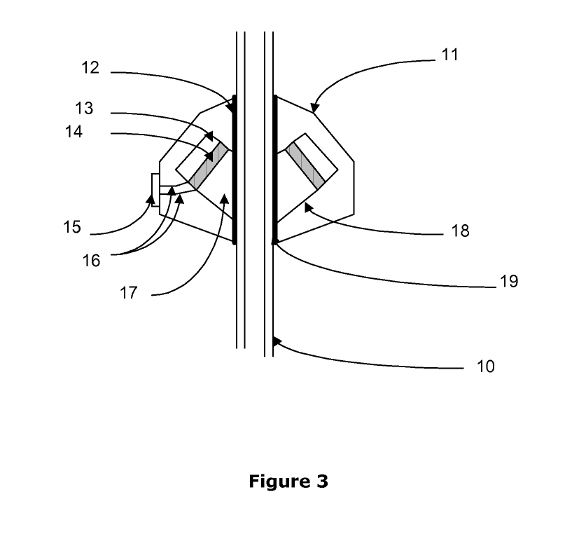

FIG. 3 shows the transmitter/receiver (transceiver) arrangement for the preferred embodiment using ultrasound. The transceiver has one or more transducer assemblies 18 surrounding the tube 10. Each transducer assembly consists of a piezo-electric element 14. The piezo-electric element can be made of a ceramic material such as PZT (lead zirconium titanate) or similar materials familiar to those skilled in the art. The element can generate ultrasound in the range 0.2 MHz-10 MHz. The ceramic has a lossy backing layer 13 to damp down the resonance of the device. The ultrasound element 14 is bonded to a front-face structure 17 which is made of a material with acoustic properties selected to couple the sound to the tube, and to act as a prism to direct the ultrasound beam parallel to the tube. The inner face of the front-face structure is cylindrical and concave to mate with the tube and is bonded to a compliant material 12 such as silicone rubber to ensure good acoustic contact with the tube. The transducer assembly is mounted in an assembly 11, which may be hinged to permit mounting on the tube. The two faces of the ultrasound element 14 are connected via wires 16 to a suitable connector 15 on the outside of the assembly.

1. An apparatus comprising a transmitter and receiver which when coupled into opposite ends of a fluid connection device can be used to verify the connection integrity of the fluid connection device, wherein if the connection is found not to be continuous appropriate investigation and corrective action can take place.

2. An apparatus, as claimed in claim 1, wherein the transmitter and receiver are based on the use of ultrasound, either pulsed or continuous.

3. An apparatus, as claimed in claim 1, wherein the transmitter and receiver are not integral to the connection device and their use is undertaken when required, for example during system set-up and/or system checking.

4. An apparatus, as claimed in claim 1, wherein information is transmitter along the connection device between the transmitter and receiver.

5. An apparatus, as claimed in claim 1, where the apparatus is an integral part of a system which is used to control the flow of fluid in the connection device.

6. An apparatus, as claimed in claim 1, wherein the transmitter and receiver are based on the use of light waves.

7. An apparatus, as claimed in claim 1, wherein the transmitter and receiver are based on the use of pressure waves

8. An apparatus as claimed in any proceeding claim wherein the system comprises a pumped drug delivery system.

9. An apparatus as claimed in any proceeding claim wherein information relating to the fluid being connected is transmitted along the connection device.
